(19) United States
(12) Patent Application Publication
(10) Pub. No.: US 2026/0189948 A1
(43) Pub. Date: Jul. 2, 2026

(54) APPARATUS AND METHOD FOR PROVIDING QUALITY OF SERVICE MONITORING EVENT EXPOSURE SERVICE IN WIRELESS COMMUNICATION SYSTEM

(71) Applicant: ELECTRONICS AND TELECOMMUNICATIONS RESEARCH INSTITUTE, Daejeon (KR)

(72) Inventors: Chang Ki KIM, Daejeon (KR); Tae Yeon KIM, Daejeon (KR); Jeoung Lak HA, Daejeon (KR)

(73) Assignee: ELECTRONICS AND TELECOMMUNICATIONS RESEARCH INSTITUTE, Daejeon (KR)

(21) Appl. No.: 19/433,643

(22) Filed: Dec. 26, 2025

(30) Foreign Application Priority Data
Dec. 30, 2024 (KR) 10-2024-0200342
Dec. 16, 2025 (KR) 10-2025-0200999

(51) Int. Cl. H04W 24/08; H04W 24/10

(52) U.S. Cl. CPC H04W 24/08; H04W 24/10

(57) ABSTRACT

The present disclosure relates generally to wireless communication systems, and more particularly, to an apparatus and method for providing a Quality of Service (QoS) monitoring event exposure service in a wireless communication system. A method of operating a Session Management Function (SMF) according to an embodiment of the present disclosure receives a QoS monitoring event subscription request from a Consumer Network Function (NF), wherein the QoS monitoring event subscription request includes Remaining Data Reporting Indication information, generates an N4 Session Reporting Rule including the Remaining Data Reporting Indication information, and transmits the N4 Session Reporting Rule to a User Plane Function (UPF) through an N4 interface.

### CROSS-REFERENCE TO RELATED APPLICATIONS

This application claims priority under 35 U.S.C. § 119 to Korean Patent Application No. 10-2024-0200342, filed on December 30, 2024, and Korean Patent Application No. 10-2025-0200999, filed on December 16, 2025, in the Korean Intellectual Property Office, the disclosures of which are incorporated herein by reference in their entirety.

### BACKGROUND OF THE INVENTION

### FIELD OF THE INVENTION

The present disclosure relates generally to wireless communication systems, and more particularly, to an apparatus and method for providing a Quality of Service (QoS) monitoring event exposure service in a wireless communication system.

### DESCRIPTION OF THE RELATED ART

3GPP SA2 (3rd Generation Partnership Project System Architecture 2), a major organization for mobile communication standardization, has sequentially begun Rel-19 Studies starting from October 2023, and study work on most items has been conducted until June 2024, with the goal of completing stage 2 normative standard specifications by December 2024.

In Rel-19, SA2 is enhancing standards regarding the provision of UPF (User Plane Function) event exposure services based on SBA (Service Based Architecture) through the second phase of UPEAS (UPF enhancement for Exposure and SBA) standardization work.

In a 5G System (5GS), the UPF is a core network function that processes user plane traffic. Traditionally, the UPF communicated only with the SMF (Session Management Function) through the N4 interface, but through recent standardization work, the UPF has been directly included in the SBA of the control plane with the Nupf interface, enabling it to communicate directly with other network functions.

Through this structural change, Consumer NFs (Network Functions) such as AF (Application Function), NEF (Network Exposure Function), or NWDAF (Network Data Analysis Function) can indirectly subscribe to QoS (Quality of Service) monitoring events from the UPF through the SMF, and when such events occur, the UPF can directly notify the Consumer NF of the results through an event exposure service.

However, the related art has the following problems. For QoS monitoring events requested from a Consumer NF to a UPF, the UPF transmits collected event result data directly to the Consumer NF periodically or within a certain time. In this situation, when an N4 session in service is released for some reason (e.g., UPF relocation, PDU (Protocol Data Unit) session release), all UPF events subscribed to that N4 session disappear. Therefore, the UPF cannot decide how to handle data that has been collected but not yet transmitted because the reporting period is not yet due, and in the simplest case, discards it.

As a result, the Consumer NF cannot receive complete QoS monitoring information, and problems arise such as loss of data necessary for network performance analysis, service quality assurance, policy decision-making, etc. In particular, data collected immediately before N4 session release may be important information indicating network status changes or problem occurrences, so the loss of such data can negatively affect service quality management.

Therefore, a clear mechanism is needed for how the UPF should handle remaining data that has been collected but not yet transmitted when an N4 session is released.

### SUMMARY OF THE INVENTION

Based on the discussion as described above, the present disclosure provides an apparatus and method for delivering remaining QoS monitoring data collected by a UPF (User Plane Function) to a Consumer NF (Network Function) when an N4 session is released in a wireless communication system.

In addition, the present disclosure provides an apparatus and method for a Consumer NF to deliver Remaining Data Reporting Indication information to a UPF when subscribing to a QoS (Quality of Service) monitoring event in a wireless communication system.

In addition, the present disclosure provides an apparatus and method for an SMF (Session Management Function) to transmit Remaining Data Reporting Indication information to a UPF through an N4 interface in a wireless communication system.

In addition, the present disclosure provides an apparatus and method for a UPF to directly transmit QoS monitoring collected data that has not been transmitted before N4 session release to a Consumer NF in a wireless communication system.

In addition, the present disclosure provides an apparatus and method for preventing loss of QoS monitoring data when a PDU (Protocol Data Unit) session is released or UPF relocation occurs in a wireless communication system.

According to various embodiments of the present disclosure, a method of operating an SMF (Session Management Function) for providing a QoS (Quality of Service) monitoring event exposure service in a wireless communication system may include receiving a QoS monitoring event subscription request from a Consumer NF (Network Function), wherein the QoS monitoring event subscription request includes Remaining Data Reporting Indication information, generating an N4 Session Reporting Rule (SRR) including the Remaining Data Reporting Indication information, and transmitting the N4 Session Reporting Rule to a UPF (User Plane Function) through an N4 interface.

According to various embodiments of the present disclosure, a method of operating a UPF for providing a QoS monitoring event exposure service in a wireless communication system may include receiving an N4 Session Reporting Rule including Remaining Data Reporting Indication information from an SMF through an N4 interface, collecting QoS monitoring data based on the N4 Session Reporting Rule, transmitting the collected QoS monitoring data to a Consumer NF according to reporting request information, identifying N4 session release, and transmitting QoS monitoring collected data that has not been transmitted to the Consumer NF before the N4 session release to the Consumer NF based on the Remaining Data Reporting Indication information.

According to various embodiments of the present disclosure, an SMF for providing a QoS monitoring event exposure service in a wireless communication system may receive a QoS monitoring event subscription request from a Consumer NF, wherein the QoS monitoring event subscription request includes Remaining Data Reporting Indication information, generate an N4 Session Reporting Rule including the Remaining Data Reporting Indication information, and transmit the N4 Session Reporting Rule to a UPF through an N4 interface.

According to various embodiments of the present disclosure, a UPF for providing a QoS monitoring event exposure service in a wireless communication system may receive an N4 Session Reporting Rule including Remaining Data Reporting Indication information from an SMF through an N4 interface, collect QoS monitoring data based on the N4 Session Reporting Rule, transmit the collected QoS monitoring data to a Consumer NF according to reporting request information, identify N4 session release, and transmit collected data that has not been transmitted to the Consumer NF before the N4 session release to the Consumer NF based on the Remaining Data Reporting Indication information.

The apparatus and method according to various embodiments of the present disclosure enable the Consumer NF to receive untransmitted data collected by the UPF even when an N4 session is released, by providing Remaining Data Reporting Indication information when subscribing to QoS monitoring events.

In addition, the apparatus and method according to various embodiments of the present disclosure enable prevention of loss of QoS monitoring data and guarantee continuity of service quality management even in PDU session release or UPF relocation situations by clarifying the remaining data processing method when an N4 session is released.

Effects obtainable from the present disclosure are not limited to the effects mentioned above, and other effects not mentioned will be clearly understood by those skilled in the art to which the present disclosure pertains from the description below.

### BRIEF DESCRIPTION OF THE DRAWINGS

FIG. 1 illustrates a 3GPP 5G system architecture in which a 5G User Plane Function (UPF) is included in a Service Based Architecture (SBA) according to various embodiments of the present disclosure.

FIG. 2A illustrates a conventional QoS monitoring event processing procedure between a Consumer NF and a UPF according to various embodiments of the present disclosure.

FIG. 2B illustrates QoS monitoring event related information included in a conventional N4 Session Reporting Rule according to various embodiments of the present disclosure.

FIG. 3 illustrates a QoS monitoring event processing procedure between a Consumer NF and a UPF according to an embodiment of the present disclosure.

FIG. 4 illustrates an N4 Session Reporting Rule including Remaining Data Reporting Indication according to an embodiment of the present disclosure.

FIG. 5 illustrates a method of operating an SMF in a wireless communication system according to an embodiment of the present disclosure.

FIG. 6 illustrates a method of operating a UPF in a wireless communication system according to an embodiment of the present disclosure.

FIG. 7 illustrates a configuration of a network entity in a wireless communication system according to an embodiment of the present disclosure.

### DETAILED DESCRIPTION OF THE EMBODIMENTS

Terms used in the present disclosure are used only to describe specific embodiments and may not be intended to limit the scope of other embodiments. Singular expressions may include plural expressions unless the context clearly indicates otherwise. Technical or scientific terms used herein may have the same meanings as commonly understood by those skilled in the art described in the present disclosure. Terms defined in a general dictionary among the terms used in the present disclosure may be interpreted to have meanings identical or similar to those in the context of related technology and, unless explicitly defined in the present disclosure, are not interpreted in an ideal or excessively formal sense. In some cases, even terms defined in the present disclosure cannot be interpreted to exclude embodiments of the present disclosure.

Various embodiments of the present disclosure described below describe a hardware approach by way of example. However, since various embodiments of the present disclosure include technology using both hardware and software, various embodiments of the present disclosure do not exclude software-based approaches.

In addition, in the detailed description and claims of the present disclosure, "at least one of A, B, and C" may mean "only A," "only B," "only C," or "any combination of A, B, and C." In addition, "at least one of A, B, or C" or "at least one of A, B, and/or C" may mean "at least one of A, B, and C."

Hereinafter, the present disclosure relates to an apparatus and method for providing a Quality of Service (QoS) monitoring event exposure service in a wireless communication system. Specifically, the present disclosure describes technology for delivering remaining QoS monitoring data collected by a UPF (User Plane Function) to a Consumer NF (Network Function) when an N4 session is released in a wireless communication system.

Terms referring to signals, terms referring to channels, terms referring to control information, terms referring to network entities, terms referring to device components, etc., used in the following description are illustrated for convenience of description. Therefore, the present disclosure is not limited to the terms described below, and other terms having equivalent technical meanings may be used.

In addition, the present disclosure describes various embodiments using terms used in some communication specifications (e.g., 3GPP (3rd Generation Partnership Project)), but these are only examples for description. Various embodiments of the present disclosure can be easily modified and applied in other communication systems.

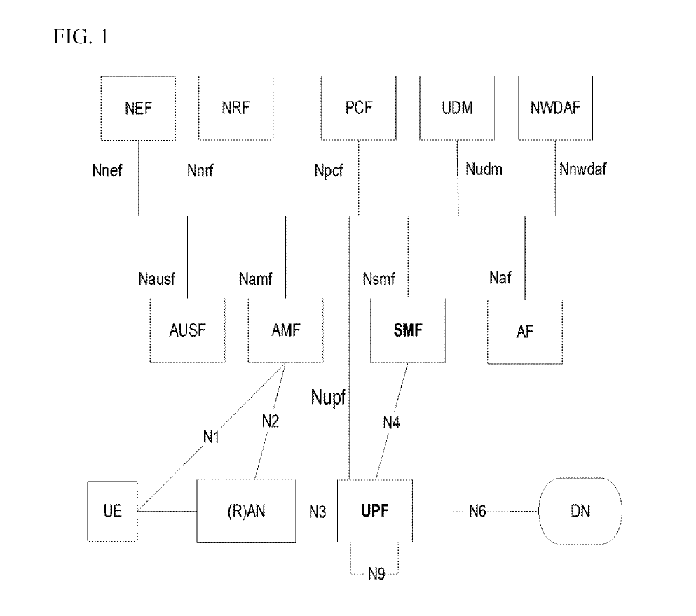

FIG. 1 illustrates a 3GPP 5G system architecture in which a 5G User Plane Function (UPF) is included in a Service Based Architecture (SBA) according to various embodiments of the present disclosure.

Referring to FIG. 1, the 5G system architecture consists of a control plane and a user plane. In the control plane, network functions such as AMF (Access and Mobility Management Function), SMF, PCF, AF (Application Function), NEF (Network Exposure Function), and NWDAF are connected through Service Based Interfaces (SBI). In the user plane, the UPF is deployed.

In various embodiments of the present disclosure, the UPF is not only connected to the SMF through the conventional N4 interface but is also directly included in the (SBA) of the control plane through the Nupf interface. Through this, the UPF can directly communicate with other network functions through SBI.

The SMF is responsible for PDU (Protocol Data Unit) session management and controls the UPF through the N4 interface. The PCF is responsible for policy control and communicates with the SMF through the Npcf interface. The AF provides application services, and the NEF provides an interface between external applications and the 5G core network. The NWDAF performs network data analysis.

In various embodiments of the present disclosure, the Consumer NF may be one of AF, NEF, or NWDAF. A scenario in which the PCF functions as a Consumer NF is also possible in the present disclosure. The Consumer NF is the entity requesting the QoS monitoring event exposure service and can directly receive QoS monitoring results from the UPF. The UPF can directly transmit event notifications to the Consumer NF through the Nupf_EventExposure service. Specifically, the UPF uses the Nupf_EventExposure_Notify operation, and when an N4 session is released, transmits QoS monitoring collected data that is in an untransmitted state because the reporting period is not yet due to the Consumer NF according to the Remaining Data Reporting Indication information.

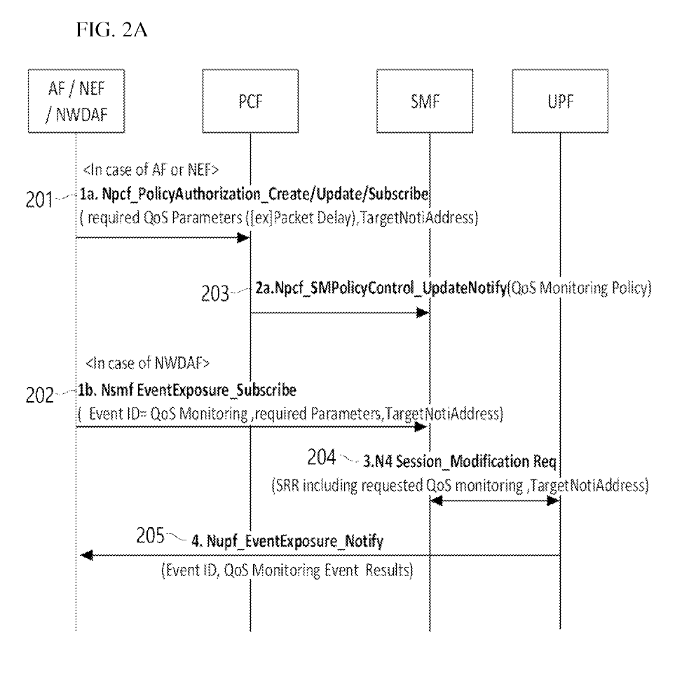

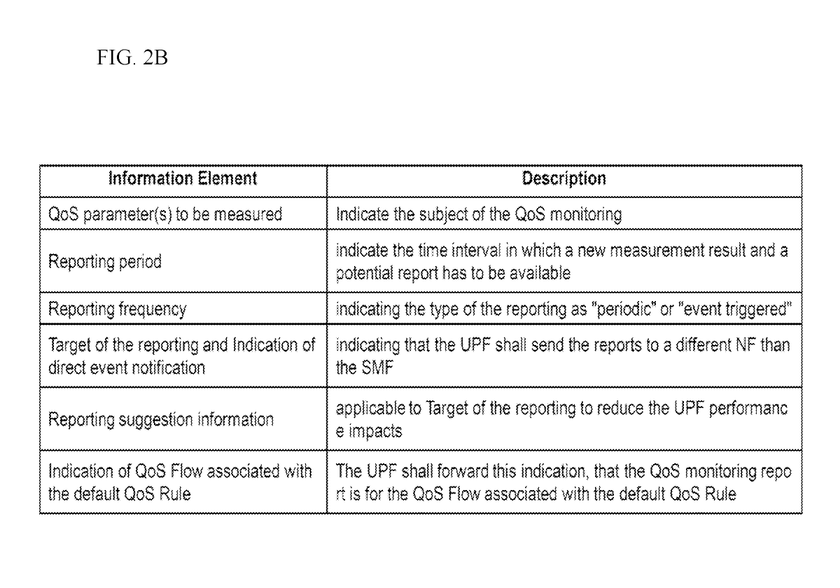

FIG. 2A illustrates a conventional QoS monitoring event processing procedure between a Consumer NF and a UPF according to various embodiments of the present disclosure.

Referring to FIG. 2A, a procedure in which a Consumer NF such as AF, NEF, or NWDAF indirectly subscribes to a QoS monitoring event from the UPF through the SMF is illustrated. The procedure is divided into two paths depending on the type of Consumer NF.

First, when the Consumer NF is AF or NEF, in step 201, the AF or NEF requests QoS monitoring event subscription to the PCF through the Npcf_PolicyAuthorization_Create/Update/Subscribe service. At this time, the request information includes necessary QoS parameters, packet delay information, target notification address (TargetNotiAddress), etc.

In step 203, the PCF delivers the QoS monitoring policy to the SMF through the Npcf_SMPolicyControl_UpdateNotify service.

Second, when the Consumer NF is NWDAF, in step 202, the NWDAF requests QoS monitoring event subscription directly to the SMF through the Nsmf_EventExposure_Subscribe service. At this time, QoS monitoring is specified as the Event ID, and necessary parameters and the target notification address are included.

In step 204, the SMF transmits the received QoS monitoring request information to the UPF by including it in an N4 Session Modification Request message. At this time, the N4 Session Reporting Rule (SRR) includes the requested QoS monitoring information and the target notification address.

After receiving the N4 Session Modification Request message, , the UPF performs QoS monitoring according to the N4 Session Reporting Rule and collects data.

In step 205, the UPF directly transmits the event identifier and collected QoS monitoring result data to the Consumer NF through the Nupf_EventExposure_Notify service according to reporting request information.

In the related art, the UPF transmits QoS monitoring results to the Consumer NF in a periodic or event-triggered manner, but when an N4 session is released, the processing method for collected data that has not been transmitted because the reporting period is not yet due was not clear.

FIG. 2B illustrates QoS monitoring event related information included in a conventional N4 Session Reporting Rule according to various embodiments of the present disclosure.

Referring to FIG. 2B, information elements related to QoS monitoring included in the N4 Session Reporting Rule transmitted by the SMF to the UPF through the N4 interface are illustrated in table form.

The first information element is QoS parameter(s) to be measured, which indicates parameters that are targets of QoS monitoring. For example, packet delay, packet loss rate, throughput, jitter, etc., may be included. Through this information element, the UPF can clearly know which QoS metrics should be measured and collected.

The second information element is Reporting period, which indicates the time interval at which new measurement results and potential reporting should be available. For example, it can be set to time units such as 1 second, 10 seconds, 1 minute, etc., and the UPF reports collected data to the Consumer NF according to this period.

The third information element is Reporting frequency, which indicates the reporting type as either "periodic" or "event triggered." In the case of periodic reporting, data is transmitted regularly according to the reporting period, and in the case of event-triggered reporting, data is transmitted when specific conditions are satisfied.

The fourth information element is Target of the reporting and Indication of direct event notification, which indicates that the UPF should send reports to a network function other than the SMF. This information element includes the target notification address of the Consumer NF, and the UPF can directly transmit QoS monitoring results to the Consumer NF using this address. Through this, delay time can be reduced and efficiency can be increased by communicating directly without going through the SMF.

The fifth information element is Reporting suggestion information, which is information for reducing UPF performance impact by bundling multiple events to be reported to the same Consumer NF reporting target into one report.

The sixth information element is Indication of QoS Flow associated with the default QoS Rule, which indicates that the UPF should convey to the Consumer NF that the QoS monitoring report is for a QoS flow associated with the default QoS rule. Through this, the Consumer NF can clearly identify which QoS flow the monitoring result is for.

In the related art, since only these information elements were included, there was no indication of how the UPF should handle remaining QoS monitoring data that has been collected but not yet transmitted when an N4 session is released. Therefore, the UPF simply discards the remaining data, and there was a problem that the Consumer NF could not receive complete QoS monitoring information.

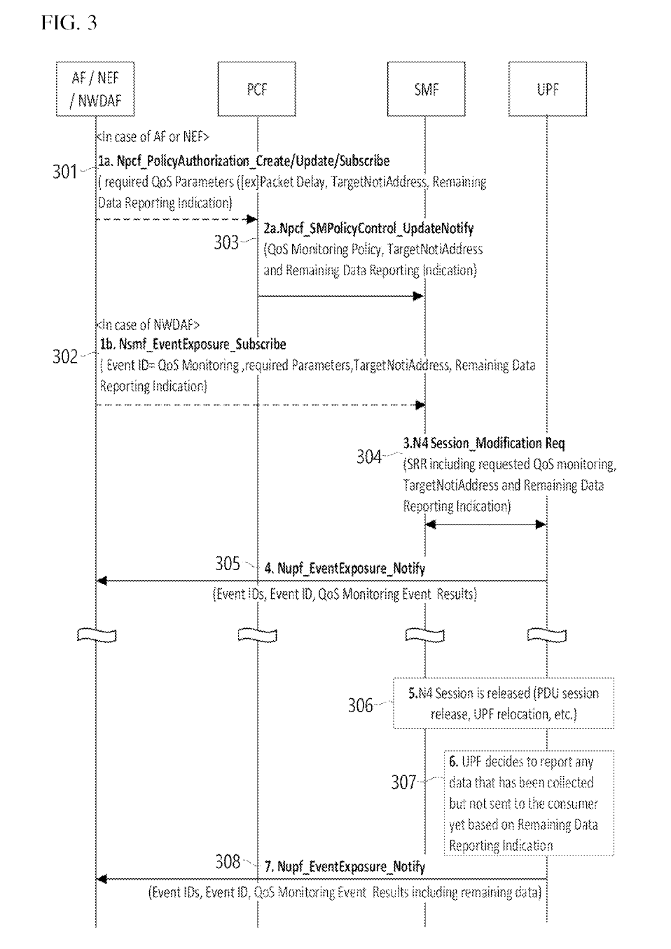

FIG. 3 illustrates a QoS monitoring event processing procedure between a Consumer NF and a UPF according to an embodiment of the present disclosure.

Referring to FIG. 3, the entire procedure is illustrated in which a Consumer NF such as AF (Application Function), NEF (Network Exposure Function), or NWDAF (Network Data Analysis Function) indirectly subscribes to a QoS monitoring event from UPF through SMF , the UPF collects and reports QoS monitoring data, and handles remaining data when an N4 session is released. The present disclosure prevents loss of collected data even in N4 session release situations by providing Remaining Data Reporting Indication information when the Consumer NF initially subscribes to events.

First, QoS monitoring event subscription is performed through two paths depending on the type of Consumer NF.

The first path is when the Consumer NF is AF or NEF. In step 301, the AF or NEF requests QoS monitoring event subscription to the PCF (Policy Control Function) through the Npcf_PolicyAuthorization_Create/Update/Subscribe service. This request message includes several information elements. First, information on QoS parameters to be measured is included, which can be, for example, Packet Delay, packet loss rate, throughput, etc. Second, a target notification address (TargetNotiAddress) for Direct Notification is included, which is the address of the Consumer NF to which the UPF will directly transmit QoS monitoring results. Third, the Remaining Data Reporting Indication information of the present disclosure is included. This information indicates whether to transmit or discard data that the UPF has collected but not yet transmitted when an N4 session is released.

In step 303, the PCF processes the QoS monitoring request information received from the AF or NEF and delivers policy information to the SMF (Session Management Function) through the Npcf_SMPolicyControl_UpdateNotify service. This message includes all of the QoS monitoring policy, target notification address, and Remaining Data Reporting Indication information. The PCF, as a network function performing policy control functions, serves to convert application requirements into session management policies and deliver them to the SMF.

The second path is when the Consumer NF is NWDAF. In step 302, the NWDAF requests QoS monitoring event subscription directly to the SMF through the Nsmf_EventExposure_Subscribe service without going through the PCF. The NWDAF is a network function that performs network data analysis and collects and analyzes data from various network functions. In this request message, QoS monitoring is specified as the Event ID, and similarly to when the Consumer NF is AF or NEF, necessary QoS parameter information, target notification address, and Remaining Data Reporting Indication information are included. Since the NWDAF has the authority to communicate directly with the SMF, it can request event subscription directly to the SMF without going through the PCF.

In step 304, the SMF converts the QoS monitoring request information received from the Consumer NF into an N4 Session Modification Request message and transmits it to the UPF. At this time, the SMF reconfigures the SRR to include the N4 Session ID corresponding to the PDU session of the corresponding UE, QFI, Event Filter, and Remaining Data Reporting Indication and delivers it to the UPF through the N4 (PFCP) interface. The SMF, as a network function responsible for session management, serves to convert information received through the service-based interface (SBI) of the control plane to the N4 interface (based on PFCP protocol) of the user plane.

The N4 Session Modification Request message includes an N4 Session Reporting Rule (SRR), which includes the following information. First, the N4 session identifier (N4 Session ID) corresponding to the PDU session of the corresponding UE (User Equipment) is included to clarify which PDU session the QoS monitoring is for. Second, the QFI (QoS Flow Identifier) is included to specify which QoS flow to monitor. Third, information on QoS parameters to be measured is included. Fourth, Reporting period information is included to specify how often the UPF should report data. Fifth, Reporting frequency information is included to specify whether it is periodic reporting or event-triggered reporting. Sixth, Target of the reporting and Indication of direct event notification information is included to inform the UPF that it should report directly to the Consumer NF and provide the target notification address. Seventh, the Remaining Data Reporting Indication information of the present disclosure is included.

The UPF receives the N4 Session Modification Request message and responds with an N4 Session Modification Response message. Through this, an agreement on QoS monitoring is reached between the SMF and the UPF. The UPF stores the received N4 Session Reporting Rule in its internal database and starts monitoring the specified QoS flow.

The UPF begins collecting QoS monitoring data according to the N4 Session Reporting Rule. The UPF analyzes packets passing through the specified QoS flow and measures QoS parameters. For example, when measuring packet delay, the UPF records the timestamp of each packet and calculates the transmission delay time. When measuring packet loss rate, it compares the number of transmitted packets and the number of received packets to calculate the loss rate. When measuring throughput, it calculates the amount of data transmitted per unit time. The collected data is temporarily stored in the UPF's internal buffer.

In step 305, the UPF transmits the collected QoS monitoring data to the Consumer NF through the Nupf_EventExposure_Notify service according to reporting request information. When the reporting frequency is periodic, the UPF transmits collected data at every specified reporting period. For example, if the reporting period is set to 10 seconds, the UPF transmits QoS monitoring results collected over the past 10 seconds to the Consumer NF every 10 seconds. When the reporting frequency is event-triggered, the UPF immediately transmits data when specific conditions are satisfied (e.g., when packet delay exceeds a threshold).

The transmitted message includes an Event ID, event identifiers, and QoS monitoring event results. The QoS monitoring event results include measured QoS parameter values, measurement time information, QoS flow identifier, etc. The Consumer NF receives this information, analyzes the network status, and can take measures such as policy adjustments or application behavior changes if necessary.

This reporting is repeatedly performed while the N4 session is maintained. The UPF continuously measures QoS parameters and transmits results to the Consumer NF at every reporting period or at each event occurrence. Through this, the Consumer NF can monitor the QoS status of the network in real time.

In step 306, a situation occurs where the N4 session is released for some reason. N4 session release can occur for various reasons. First, PDU session release can occur. This occurs when the UE terminates the network connection, when an application terminates, or when a session is forcibly terminated according to network policy. Second, UPF relocation can occur. This occurs when a session needs to be moved to another UPF due to UE mobility or when load balancing is needed for network optimization. Third, N4 session release can also occur when the UPF restarts or service is interrupted due to network failure or maintenance.

When an N4 session is released, all rules and state information associated with that session are deleted. At this time, an important problem arises: there may be remaining data that the UPF has collected QoS monitoring data but has not transmitted to the Consumer NF because the reporting period is not yet due. For example, if the reporting period is set to 10 seconds and the N4 session is released 7 seconds after the last report, the data collected during those 7 seconds has not yet been transmitted. In the related art, since there was no clear guidance on how to handle such remaining data, the UPF simply discarded the data, resulting in the problem that the Consumer NF receives only incomplete QoS monitoring collected information.

In step 307, the UPF detects N4 session release and refers to the Remaining Data Reporting Indication information included in the N4 Session Reporting Rule. The UPF searches the internal database for the N4 Session Reporting Rule associated with that N4 session and checks the value of the Remaining Data Reporting Indication information. In addition, the UPF checks the internal buffer to examine whether there is QoS monitoring data that has been collected but not yet transmitted to the Consumer NF.

When the Remaining Data Reporting Indication information indicates transmission to the Consumer NF, the UPF decides to transmit the remaining data to the Consumer NF. Conversely, when the Remaining Data Reporting Indication information indicates data discard, the UPF deletes the remaining data and does not transmit it. Through this decision process, the UPF can appropriately handle remaining data according to the Consumer NF's initial requirements.

In step 308, when the Remaining Data Reporting Indication information indicates transmission, the UPF transmits QoS monitoring event results including the remaining data to the Consumer NF using the Nupf_EventExposure_Notify service. This message includes event identifiers along with QoS monitoring event results including the remaining data.

The transmitted remaining data includes all QoS measurement information collected since the last regular report. For example, packet delay data, packet loss rate data, throughput data, etc., collected during the 7 seconds since the last report are all included. In addition, an indicator indicating that this data is the final report due to N4 session release may be included. Through this information, the Consumer NF can recognize that data collection has ended and include the received data in the final analysis.

Through this, the Consumer NF can receive complete QoS monitoring information even when an N4 session is released. The Consumer NF can construct a complete QoS profile for the entire session period by combining data received through regular reports with the final remaining data. This can be utilized for various purposes such as network performance analysis, service quality assurance, billing, and user experience evaluation.

According to an embodiment of the present disclosure, through the Remaining Data Reporting Indication information, the UPF can clearly determine whether to transmit or discard collected remaining data when an N4 session is released. Through this, the following effects can be obtained.

First, the Consumer NF can receive complete information without loss of QoS monitoring data. This has important meaning especially in network data analysis, service quality assurance, and precise billing.

Second, the Consumer NF can select the remaining data processing method according to its own requirements. For example, when precise analysis is needed, it can be set to receive remaining data, and when only a rough trend grasp is needed, it can be set to discard remaining data to prevent unnecessary data transmission.

Third, continuity of service quality management can be guaranteed. Even if network events such as PDU session release or UPF relocation occur, the Consumer NF can manage service quality based on complete QoS information without interruption.

Fourth, the reliability of the 5G system can be improved. By preventing data loss, network operators and service providers can make decisions based on more accurate network status information.

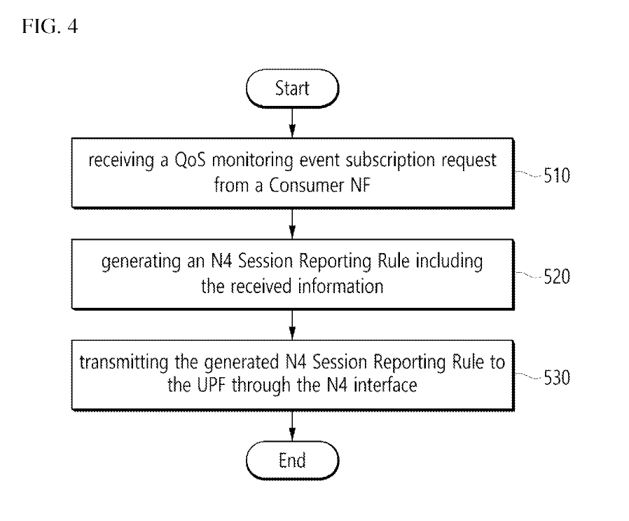

FIG. 4 illustrates an N4 Session Reporting Rule including Remaining Data Reporting Indication according to an embodiment of the present disclosure.

Referring to FIG. 4, information elements related to QoS monitoring included in the N4 Session Reporting Rule (SRR) transmitted by the SMF to the UPF through the N4 interface are illustrated in table form. According to an embodiment of the present disclosure, the N4 Session Reporting Rule of FIG. 4 additionally includes a Remaining Data Reporting Indication information element compared to the conventional N4 Session Reporting Rule illustrated in FIG. 2B.

The newly added Remaining Data Reporting Indication information element is the Remaining Data Reporting Indication according to the present disclosure, which indicates the processing method for QoS monitoring data that the UPF has collected but not yet transmitted to the Consumer NF when an N4 session is released. This information element can have two values. The first is a value indicating to transmit the remaining data to the Consumer NF, and the second is a value indicating to discard the remaining data. According to an embodiment, the Remaining Data Reporting Indication is limited to two values: transmit or discard.

When the UPF detects N4 session release, it checks the Remaining Data Reporting Indication information and operates as follows. If the Remaining Data Reporting Indication indicates transmission, the UPF immediately transmits all data that has been collected but not yet transmitted to the Consumer NF because the reporting period is not yet due . Through this, the Consumer NF can receive complete QoS monitoring information, and continuous service quality management is possible without data loss even in situations such as PDU session release or UPF relocation. Conversely, if the Remaining Data Reporting Indication indicates discard, the UPF deletes the collected remaining data without transmitting it.

According to an embodiment of the present disclosure, through the addition of the Remaining Data Reporting Indication information element, the data loss problem that can occur when an N4 session is released can be effectively solved. The Consumer NF can secure necessary data or prevent unnecessary data transmission even in N4 session release situations by setting the Remaining Data Reporting Indication information according to its own requirements when initially subscribing to QoS monitoring events. Through this, both the reliability and efficiency of QoS monitoring services in 5G systems can be improved simultaneously.

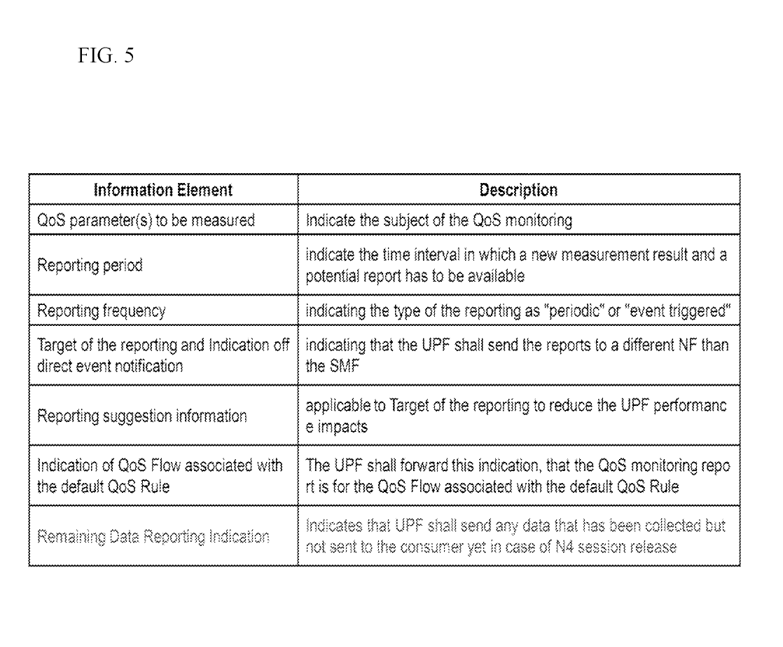

FIG. 5 illustrates a method of operating an SMF in a wireless communication system according to an embodiment of the present disclosure.

Referring to FIG. 5, a method in which the SMF receives a QoS monitoring event subscription request from a Consumer NF, processes it, and delivers it to the UPF is illustrated in flowchart form. The method of operating the SMF according to an embodiment of the present disclosure corresponds to claim 1 and includes the process of delivering Remaining Data Reporting Indication information to the UPF.

In step 510, the SMF receives a QoS monitoring event subscription request from a Consumer NF. This step can be implemented in various embodiments depending on the type of Consumer NF.

In one embodiment, when the Consumer NF is AF (Application Function) or NEF (Network Exposure Function), the SMF can indirectly receive the subscription request through the PCF (Policy Control Function). Specifically, the AF or NEF first transmits a QoS monitoring request to the PCF through the Npcf_PolicyAuthorization_Create/Update/Subscribe service. At this time, the AF or NEF delivers application-level QoS requirements expressed in policy form. The PCF receives this, performs policy decision, and delivers the QoS monitoring policy to the SMF through the Npcf_SMPolicyControl_UpdateNotify service. In this process, QoS parameters, target notification address, and Remaining Data Reporting Indication information requested by the AF or NEF are delivered to the SMF via the PCF.

In another embodiment, when the Consumer NF is NWDAF (Network Data Analysis Function), the NWDAF can communicate directly with the SMF without going through the PCF. The NWDAF requests QoS monitoring event subscription directly to the SMF through the Nsmf_EventExposure_Subscribe service. In this case, the NWDAF specifies QoS monitoring as the Event ID and directly delivers necessary parameters to the SMF. And the Remaining Data Reporting Indication information is also delivered to the SMF.

In various embodiments, the QoS monitoring event subscription request received by the SMF commonly includes the following information. First, information on QoS parameters to be measured is included, which can include various QoS metrics such as packet delay, packet loss rate, throughput, jitter, etc. Second, Reporting period information is included to specify how often the UPF should report data. Third, Reporting frequency information is included to specify periodic reporting or event-triggered reporting. Fourth, a target notification address (TargetNotiAddress) for Direct Notification is included to enable the UPF to report directly to the Consumer NF. Fifth, the present disclosure includes Remaining Data Reporting Indication information.

In one embodiment, the Remaining Data Reporting Indication information can be expressed as a Boolean value. For example, a "true" value indicates to transmit remaining data to the Consumer NF when an N4 session is released, and a "false" value can indicate to discard remaining data.

In another embodiment, the Remaining Data Reporting Indication information can be expressed as an Enumeration value. For example, "SEND_REMAINING_DATA" indicates transmission, "DISCARD_REMAINING_DATA" indicates discard, and "SEND_IF_SIGNIFICANT" can indicate to transmit only when the amount of collected data is above a certain threshold.

In yet another embodiment, the Remaining Data Reporting Indication information can be provided together with additional parameters. For example, a minimum data threshold can be provided together to transmit only when the amount of collected data is above the threshold. Or a maximum delay time can be provided together to limit transmission of remaining data only within a certain time after N4 session release.

In step 520, the SMF generates an N4 Session Reporting Rule including the received information. In this step, the SMF converts information received through the service-based interface of the control plane into the N4 interface format of the user plane.

In one embodiment, when there is an already established N4 session, the SMF adds a new N4 Session Reporting Rule to that N4 session. In this case, the SMF identifies the session using the N4 Session ID and adds the new rule.

In another embodiment, when an N4 session has not yet been established, the SMF first establishes an N4 session and includes the N4 Session Reporting Rule in that process. In this case, the N4 Session Reporting Rule is included in the N4 Session Establishment Request message.

In yet another embodiment, when modifying an existing N4 Session Reporting Rule, the SMF updates the rule using the identifier of the existing rule. For example, the reporting period can be changed or the Remaining Data Reporting Indication setting can be changed.

In step 530, the SMF transmits the generated N4 Session Reporting Rule to the UPF through the N4 interface.

In one embodiment, the SMF can transmit the N4 Session Reporting Rule to the UPF by including it in an N4 Session Modification Request message. At this time, the N4 Session Reporting Rule includes QoS parameters to be measured, reporting period, reporting frequency, target notification address, and Remaining Data Reporting Indication information.

In another embodiment, when an N4 session has not yet been established, the SMF can transmit the N4 Session Reporting Rule to the UPF by including it in an N4 Session Establishment Request message.

The SMF can receive an N4 Session Modification Response or N4 Session Establishment Response message from the UPF to confirm that the N4 Session Reporting Rule has been successfully established.

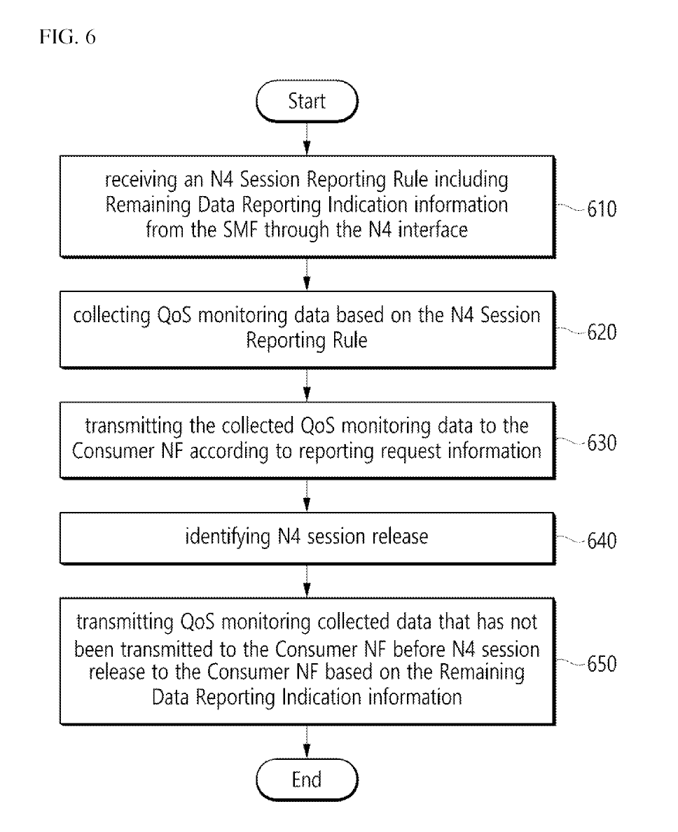

FIG. 6 illustrates a method of operating a UPF in a wireless communication system according to an embodiment of the present disclosure.

Referring to FIG. 6, a method in which the UPF receives an N4 Session Reporting Rule from the SMF, collects and reports QoS monitoring data, and processes remaining data when an N4 session is released is illustrated in flowchart form. The method of operating the UPF according to an embodiment of the present disclosure corresponds to claim 6 and includes the process of transmitting remaining data collected before N4 session release to the Consumer NF based on Remaining Data Reporting Indication information.

In step 610, the UPF receives an N4 Session Reporting Rule including Remaining Data Reporting Indication information from the SMF through the N4 interface. This step can be implemented through various N4 message types and scenarios.

In one embodiment, the UPF can receive the N4 Session Reporting Rule through an N4 Session Modification Request message. In this case, a new QoS monitoring rule is being added to an already established N4 session. When the UPF receives the message, it first identifies the N4 session by checking the N4 session identifier and associates the received N4 Session Reporting Rule with that session. The UPF responds to the SMF with the processing result in an N4 Session Modification Response message.

In another embodiment, the UPF can receive the N4 Session Reporting Rule through an N4 Session Establishment Request message. In this case, QoS monitoring is being established simultaneously as a new PDU session is created. The UPF creates a new N4 session and stores all session information including the N4 Session Reporting Rule in its internal database. The UPF responds with an N4 Session Establishment Response message.

In yet another embodiment, when modifying an existing N4 Session Reporting Rule, the UPF receives the updated rule through an N4 Session Modification Request message. In this case, the UPF finds the corresponding rule using the identifier of the existing rule and updates the parameters. For example, the reporting period can be changed from 10 seconds to 30 seconds, or the Remaining Data Reporting Indication can be changed from "transmit" to "discard."

The N4 Session Reporting Rule received by the UPF includes the following information. First, QoS parameter(s) to be measured information is included to specify which QoS metrics should be measured. Second, Reporting period information is included to specify the data reporting interval. Third, Reporting frequency information is included to specify periodic reporting or event-triggered reporting. Fourth, Target of the reporting and Indication of direct event notification information is included to indicate that the UPF should report directly to the Consumer NF. Fifth, Notification Target Address information is included to provide a URI or IP address through which the UPF can access the Consumer NF. Sixth, QoS Flow Identifier (QFI) information is included to specify the QoS flow to be monitored. Seventh, the present disclosure includes Remaining Data Reporting Indication information.

In one embodiment, when receiving an N4 Session Reporting Rule, the UPF validates the rule. For example, the UPF checks whether it has the capability to measure the requested QoS parameters, verifies that the reporting period is not shorter than the UPF's minimum supported period, and validates that the target notification address is in a valid format. If validation fails, the UPF includes error information in the N4 response message and notifies the SMF.

In another embodiment, the UPF stores the received N4 Session Reporting Rule in an internal data structure. This data structure is designed to support fast search and update and is indexed using keys such as N4 session identifier, QoS flow identifier, rule identifier, etc. The UPF also stores metadata such as rule creation time, last report time, next scheduled report time, etc.

In yet another embodiment, the UPF can simultaneously process QoS monitoring requests from multiple Consumer NFs. In this case, the UPF manages each N4 Session Reporting Rule independently and performs separate data collection and reporting for each rule. Even when there are multiple rules for the same QoS flow, the UPF processes each individually according to each rule's requirements.

In step 620, the UPF collects QoS monitoring data based on the N4 Session Reporting Rule. This step can be implemented in various ways depending on the type of QoS parameters.

In one embodiment, when measuring Packet Delay, the UPF records the timestamp of each packet. For uplink packets, the UPF calculates the difference between the time the packet was received and the time it was transmitted to the data network. For downlink packets, the UPF calculates the difference between the time it was received from the data network and the time it was transmitted to the radio access network. The UPF stores these delay values in a buffer and calculates statistical information (average, minimum, maximum, standard deviation, etc.).

In another embodiment, when measuring Packet Loss Rate, the UPF counts the number of transmitted packets and the number of successfully acknowledged packets. The UPF identifies lost packets using sequence numbers and calculates the loss rate as a percentage. The UPF can also record time and location information where loss occurred.

In yet another embodiment, when measuring Throughput, the UPF calculates the amount of data transmitted per unit time. The UPF maintains a byte counter and reads the counter value at specified time intervals to calculate throughput and reset the counter. Throughput can be expressed in units of bits/second (bps), kilobits/second (Kbps), or megabits/second (Mbps).

In another embodiment, the UPF can compress and store collected data. For example, instead of storing all individual packet delay values, memory usage can be reduced by storing only aggregated statistical information (average, minimum, maximum, variance, etc.) for each time period. This is particularly useful when the reporting period is long.

In yet another embodiment, the UPF can perform monitoring for multiple QoS flows in parallel. The UPF maintains an independent data collection process for each QoS flow and can increase efficiency by utilizing multithreading or multiprocessing techniques.

In one embodiment, the UPF can detect and handle abnormal situations during data collection. For example, when packet delay becomes abnormally high or packet loss rate exceeds a threshold, the UPF can immediately detect this and notify the Consumer NF in an event-triggered manner. This applies when the reporting frequency is set to "event triggered."

In step 630, the UPF transmits the collected QoS monitoring data to the Consumer NF according to reporting request information. This step can be implemented differently depending on the reporting frequency setting.

In one embodiment, when the reporting frequency is set to "periodic," the UPF transmits collected data to the Consumer NF at every specified reporting period. The UPF tracks the reporting period using an internal timer, and when the timer expires, aggregates the data collected during that period and transmits it through the Nupf_EventExposure_Notify service operation. For example, if the reporting period is set to 10 seconds, the UPF transmits QoS measurement results for the past 10 seconds to the Consumer NF every 10 seconds.

In another embodiment, when the reporting frequency is set to "event triggered," the UPF immediately transmits data when specific conditions are satisfied. Trigger conditions are defined in the N4 Session Reporting Rule and can be, for example, "when packet delay exceeds 100ms," "when packet loss rate exceeds 5%," "when throughput falls below 1Mbps," etc. The UPF monitors QoS parameters in real time and immediately notifies the Consumer NF when trigger conditions are detected.

In yet another embodiment, periodic reporting and event-triggered reporting can be used in combination. For example, periodic reporting can be performed every 30 seconds by default, and when severe QoS degradation is detected, event-triggered reporting can be additionally performed immediately.

The message transmitted by the UPF to the Consumer NF includes the following information. First, an Event ID is included to indicate that this notification is about a QoS monitoring event. Second, a QoS flow identifier is included to specify which QoS flow the measurement result is for. Third, measurement time information is included to indicate the time period during which data was collected. Fourth, QoS monitoring results are included, which include measured QoS parameter values (e.g., average packet delay 50ms, packet loss rate 0.5%, throughput 10Mbps). Fifth, additional metadata (e.g., number of packets measured, sampling rate, reliability indicator, etc.) may be included.

In one embodiment, when the UPF needs to transmit reports to multiple Consumer NFs simultaneously, it performs an independent transmission process for each Consumer NF. Each Consumer NF can have a different target notification address, and the UPF transmits a separate message to each address.

In one embodiment, the UPF logs transmission records after report transmission. The log includes transmission time, summary of transmitted data, address of Consumer NF, transmission result (success or failure), etc. This log can be used for purposes such as troubleshooting, auditing, and statistical analysis.

In step 640, the UPF identifies N4 session release. This step can occur in various scenarios.

In step 650, the UPF transmits QoS monitoring collected data that has not been transmitted to the Consumer NF before N4 session release to the Consumer NF based on the Remaining Data Reporting Indication information.

In one embodiment, when the UPF detects N4 session release, it refers to the Remaining Data Reporting Indication information included in the N4 Session Reporting Rule associated with that N4 session. When the Remaining Data Reporting Indication information indicates transmission to the Consumer NF, the UPF immediately transmits collected data that has not yet been transmitted to the Consumer NF because the reporting period is not due .

In one embodiment, the UPF directly transmits QoS monitoring event results including remaining data to the Consumer NF using the Nupf_EventExposure_Notify service operation. At this time, the transmitted message may include an indicator indicating that this is the final report due to N4 session release along with the event identifier.

In another embodiment, when the Remaining Data Reporting Indication information indicates data discard, the UPF deletes collected remaining data without transmitting it.

Through this, the Consumer NF can receive complete QoS monitoring information even in N4 session release situations such as PDU session release or UPF relocation, and continuous service quality management is possible without data loss.

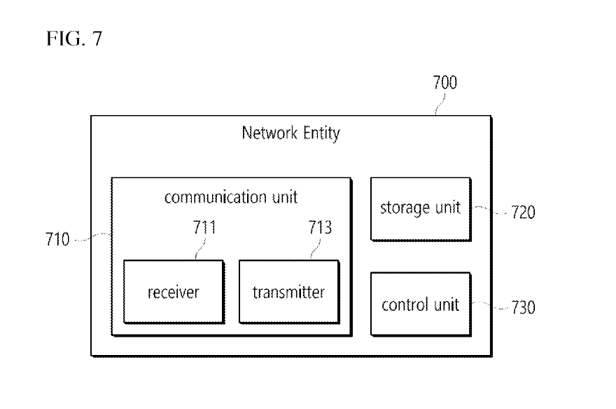

FIG. 7 illustrates a configuration of a network entity in a wireless communication system according to an embodiment of the present disclosure. The network entity of the present disclosure is a concept including network functions depending on system implementation. Terms such as '~ unit', '~ device', etc., used hereinafter mean units that process at least one function or operation and can be implemented in hardware or software, or a combination of hardware and software.

Referring to FIG. 7, a network entity 700 according to various embodiments of the present disclosure may include a communication unit 710, a storage unit 720, and a control unit 730 that controls overall operations of the network entity 700.

The communication unit 710 transmits and receives signals with other network entities. In one embodiment, the communication unit 710 can communicate with other network functions through a Service Based Interface (SBI). For example, when the network entity 700 is an SMF, the communication unit 710 communicates with the PCF, UPF, NWDAF, etc. In another embodiment, when the network entity 700 is a UPF, the communication unit 710 communicates with the SMF through the N4 interface and communicates with the Consumer NF through the Nupf interface.

All or part of the communication unit 710 may be referred to as a 'transmitter 711', 'receiver 713', or 'transceiver 710'. In one embodiment, the transmitter 711 performs the function of transmitting messages such as N4 Session Reporting Rule, QoS monitoring event subscription request, QoS monitoring event notification, etc. The receiver 713 performs the function of receiving these messages.

The storage unit 720 stores data such as basic programs, application programs, and configuration information for operation of the network entity 700. The storage unit 720 may be composed of volatile memory, non-volatile memory, or a combination of volatile memory and non-volatile memory.

In one embodiment, when the network entity 700 is an SMF, the storage unit 720 can store QoS monitoring event subscription request information received from the Consumer NF, generated N4 Session Reporting Rule, N4 session state information, Remaining Data Reporting Indication information, etc. In another embodiment, when the network entity 700 is a UPF, the storage unit 720 can store the N4 Session Reporting Rule received from the SMF, collected QoS monitoring data, Remaining Data Reporting Indication information, target notification address of the Consumer NF, etc.

The storage unit 720 provides stored data upon request from the control unit 730. For example, when an N4 session is released, the control unit 730 of the UPF searches and reads the N4 Session Reporting Rule and Remaining Data Reporting Indication information associated with that N4 session from the storage unit 720.

The control unit 730 controls overall operations of the network entity 700. For example, the control unit 730 transmits and receives signals through the communication unit 710. In addition, the control unit 730 writes and reads data in the storage unit 720. And the control unit 730 can perform functions of protocol stacks required by communication specifications.

To this end, the control unit 730 may include a circuit, an application-specific circuit, at least one processor or microprocessor, or may be part of a processor. In addition, part of the communication unit 710 and the control unit 730 may be referred to as a communication processor (CP).

The control unit 730 can control the network entity 700 to perform operations of any one of various embodiments of the present disclosure.

In one embodiment, when the network entity 700 is an SMF, the control unit 730 controls the network entity 700 to perform the method of operating the SMF illustrated in FIG. 5. Specifically, the control unit 730 controls the communication unit 710 to receive a QoS monitoring event subscription request including Remaining Data Reporting Indication information from the Consumer NF, generates an N4 Session Reporting Rule including the received information, and controls the communication unit 710 to transmit the generated N4 Session Reporting Rule to the UPF through the N4 interface.

In another embodiment, when the network entity 700 is a UPF, the control unit 730 controls the network entity 700 to perform the method of operating the UPF illustrated in FIG. 6. Specifically, the control unit 730 controls the communication unit 710 to receive an N4 Session Reporting Rule including Remaining Data Reporting Indication information from the SMF through the N4 interface, collects QoS monitoring data based on the N4 Session Reporting Rule, controls the communication unit 710 to transmit the collected QoS monitoring data to the Consumer NF according to reporting request information, identifies N4 session release, and controls the communication unit 710 to transmit collected data that has not been transmitted to the Consumer NF before N4 session release to the Consumer NF based on the Remaining Data Reporting Indication information.

In yet another embodiment, when the network entity 700 is a PCF, the control unit 730 controls the network entity 700 to perform a relay function of receiving a QoS monitoring event subscription request from the AF or NEF and delivering it to the SMF.

In one embodiment, the control unit 730 converts the Remaining Data Reporting Indication information into an appropriate format when generating an N4 Session Reporting Rule. For example, it converts information in service-based interface format transmitted by the Consumer NF into N4 interface format.

In another embodiment, when detecting N4 session release, the control unit 730 searches all N4 Session Reporting Rules associated with that N4 session from the storage unit 720 and performs remaining data processing operations for each rule.

In yet another embodiment, the control unit 730 controls to transmit a message to the Consumer NF using the Nupf_EventExposure_Notify service through the communication unit 710 when transmitting remaining data.

The communication unit 710 and control unit 730 do not necessarily have to be implemented as separate modules and can of course be implemented as one component in the form of a single chip or software block. The communication unit 710, storage unit 720, and control unit 730 can be electrically connected.

In addition, operations of the network entity 700 can be realized by including the storage unit 720 storing corresponding program code in the network entity 700. That is, the control unit 730 can perform operations according to various embodiments of the present disclosure by executing program code stored in the storage unit 720.

The network entity 700 includes network nodes and may be any one of RAN, AMF (Access and Mobility Management Function), SMF (Session Management Function), UPF (User Plane Function), NF (Network Function), NEF (Network Exposure Function), NRF (Network Repository Function), CHF (Charging Function), NSSF (Network Slice Selection Function), UDM (Unified Data Management), AF (Application Function), AUSF (Authentication Server Function), SCP (Service Communication Proxy), UDSF (Unstructured Data Storage Function), context storage, OAM (Operations, Administration and Maintenance), EMS (Element Management System), configuration server, identifier (ID) management server.

In one embodiment, when the network entity 700 is an SMF, the communication unit 710 communicates with other network functions through the Nsmf interface and communicates with the UPF through the N4 interface. The control unit 730 performs operations of the SMF described in claims 1 to 5 and claims 11 to 15.

In another embodiment, when the network entity 700 is a UPF, the communication unit 710 communicates with the SMF through the N4 interface and communicates with the Consumer NF through the Nupf interface. The control unit 730 performs operations of the UPF described in claims 6 to 10 and claims 16 to 20.

In yet another embodiment, when the network entity 700 is a PCF, the communication unit 710 communicates with the AF, NEF, SMF, etc., through the Npcf interface. The control unit 730 performs policy control functions of processing QoS monitoring event subscription requests received from the AF or NEF and delivering them to the SMF.

In one embodiment, when the network entity 700 is AF, NEF, or NWDAF, they operate as a Consumer NF, and the communication unit 710 transmits QoS monitoring event subscription requests to the SMF or PCF and receives QoS monitoring event notifications from the UPF. The control unit 730 requests by including Remaining Data Reporting Indication information when subscribing to QoS monitoring events, and analyzes QoS monitoring data received from the UPF for use in network optimization, service quality assurance, policy decision-making, etc.

The configuration of the network entity 700 according to various embodiments of the present disclosure provides a hardware and software structure for providing QoS monitoring event exposure services in5G systems. In particular, by including a configuration capable of processing Remaining Data Reporting Indication information and appropriately handling remaining data when an N4 session is released, the technical features of the present disclosure can be implemented.

Methods according to embodiments described in the claims or specification of the present disclosure can be implemented in the form of hardware, software, or a combination of hardware and software.

When implemented in software, a computer-readable storage medium storing one or more programs (software modules) can be provided. The one or more programs stored in the computer-readable storage medium are configured for execution by one or more processors within an electronic device. The one or more programs include instructions that cause the electronic device to execute methods according to embodiments described in the claims or specification of the present disclosure.

Such programs (software modules, software) can be stored in random access memory, non-volatile memory including flash memory, read only memory (ROM), electrically erasable programmable read only memory (EEPROM), magnetic disc storage device, compact disc-ROM (CD-ROM), digital versatile discs (DVDs) or other forms of optical storage devices, magnetic cassettes. Or they can be stored in memory composed of some or all combinations thereof. In addition, each component memory may be included in plurality.

In addition, programs can be stored in attachable storage devices that can be accessed through communication networks such as the Internet, Intranet, local area network (LAN), wide area network (WAN), or storage area network (SAN), or communication networks composed of combinations thereof. Such storage devices can connect to devices performing embodiments of the present disclosure through external ports. In addition, separate storage devices on the communication network can also connect to devices performing embodiments of the present disclosure.

In the specific embodiments of the present disclosure described above, components included in the disclosure are expressed in singular or plural form according to the specific embodiments presented. However, singular or plural expressions are selected appropriately for situations presented for convenience of description, and the present disclosure is not limited to singular or plural components, and even components expressed in plural form can be composed in singular form, or even components expressed in singular form can be composed in plural form.

Meanwhile, although specific embodiments have been described in the detailed description of the present disclosure, various modifications are possible without departing from the scope of the present disclosure. Therefore, the scope of the present disclosure should not be limited to the described embodiments but should be determined by the scope of the claims described below as well as equivalents of this scope of claims.

What is claimed is:

1. A method of operating a Session Management Function (SMF) for providing a Quality of Service (QoS) monitoring event exposure service in a wireless communication system, the method comprising:
receiving a QoS monitoring event subscription request from a Consumer Network Function (NF), wherein the QoS monitoring event subscription request includes Remaining Data Reporting Indication information;
generating an N4 Session Reporting Rule (SRR) including the Remaining Data Reporting Indication information; and
transmitting the N4 Session Reporting Rule to a User Plane Function (UPF) through an N4 interface.

2. The method of claim 1, wherein receiving the QoS monitoring event subscription request comprises:
when the Consumer NF is an Application Function (AF) or a Network Exposure Function (NEF), receiving through a Policy Control Function (PCF) via an Npcf_PolicyAuthorization service and an Npcf_SMPolicyControl service; or
when the Consumer NF is a Network Data Analysis Function (NWDAF), receiving directly through an Nsmf_EventExposure service.

3. The method of claim 1, wherein the QoS monitoring event subscription request further comprises:
request information for QoS monitoring; and
Notification Target Address information for Direct Notification.

4. The method of claim 1, wherein the N4 Session Reporting Rule further comprises:
information on QoS parameters to be measured;
Reporting period information;
Reporting frequency information; and
Target of reporting and Indication of direct event notification information.

5. The method of claim 1, wherein the Remaining Data Reporting Indication information is information indicating a processing method for data that the UPF has collected but has not been transmitted to the Consumer NF when an N4 session is released, and
the processing method indicates one of discarding the data or transmitting the data to the Consumer NF.

6. A method of operating a User Plane Function (UPF) for providing a QoS monitoring event exposure service in a wireless communication system, the method comprising:
receiving an N4 Session Reporting Rule including Remaining Data Reporting Indication information from a Session Management Function (SMF) through an N4 interface;
collecting Quality of Service (QoS) monitoring data based on the N4 Session Reporting Rule;
transmitting the collected QoS monitoring data to a Consumer Network Function (NF) according to reporting request information;
identifying N4 session release; and
transmitting collected data that has not been transmitted to the Consumer NF before the N4 session release to the Consumer NF based on the Remaining Data Reporting Indication information.

7. The method of claim 6, wherein transmitting the collected QoS monitoring data comprises:
directly transmitting to the Consumer NF using an Nupf_EventExposure_Notify service operation.

8. The method of claim 6, wherein identifying the N4 session release comprises:
identifying the N4 session release due to one of Protocol Data Unit (PDU) session release or UPF relocation.

9. The method of claim 6, wherein transmitting the collected data that has not been transmitted before the N4 session release comprises:
when the Remaining Data Reporting Indication information indicates transmission to the Consumer NF, transmitting the collected data to the Consumer NF using an Nupf_EventExposure_Notify service operation.

10. The method of claim 6, wherein the N4 Session Reporting Rule further comprises:
information on QoS parameters to be measured;
Reporting period information;
Reporting frequency information; and
Target of reporting and Indication of direct event notification information.

11. A Session Management Function (SMF) for providing a Quality of Service (QoS) monitoring event exposure service in a wireless communication system, the SMF comprising:
a transceiver; and
a processor operably connected to the transceiver,
wherein the processor is configured to:
receive a QoS monitoring event subscription request from a Consumer Network Function (NF),
wherein the QoS monitoring event subscription request includes Remaining Data Reporting Indication information,
generate an N4 Session Reporting Rule including the Remaining Data Reporting Indication information, and
transmit the N4 Session Reporting Rule to a User Plane Function (UPF) through an N4 interface.

12. The SMF of claim 11, wherein the processor is configured to:
when the Consumer NF is AF or NEF, receive the QoS monitoring event subscription request via PCF through an Npcf_PolicyAuthorization service and an Npcf_SMPolicyControl service; or
when the Consumer NF is NWDAF, directly receive the QoS monitoring event subscription request through an Nsmf_EventExposure service.

13. The SMF of claim 11, wherein the QoS monitoring event subscription request further comprises:
request information for QoS monitoring; and
Notification Target Address information for Direct Notification.

14. The SMF of claim 11, wherein the N4 Session Reporting Rule further comprises:
information on QoS parameters to be measured;
Reporting period information;
Reporting frequency information; and
Target of reporting and Indication of direct event notification information.

15. The SMF of claim 11, wherein the Remaining Data Reporting Indication information is information indicating a processing method for data that the UPF has collected but has not been transmitted to the Consumer NF when an N4 session is released, and
the processing method indicates one of discarding the data or transmitting the data to the Consumer NF.
